(19) United States
(12) Patent Application Publication
(10) Pub. No.: US 2011/0188089 A1
(43) Pub. Date: Aug. 4, 2011

(54) METHOD AND ARRANGEMENT FOR AUTOMATIC VERIFICATION OF THE VISUALLY PERCEIVED COLOR IMPRESSION OF MULTICOLOR COLOR IMAGES

(76) Inventors: Robert Massen, Oehningen (DE); Joerg Eberhardt, Sibratshaus (DE)

(21) Appl. No.: 12/934,070

(22) PCT Filed: Mar. 26, 2009
(86) PCT No.: PCT/EP09/02238

§ 371 Date: Nov. 4, 2010

(30) Foreign Application Priority Data
Mar. 29, 2008 (DE) 10 2008 016 538.7

(51) Int. Cl. H04N 1/407; G06K 9/36

(52) U.S. Cl. 358/3.24; 382/167

(57) ABSTRACT

A method and arrangement that automatically verify a visually perceived color impression of multicolor color images in a printed product having text in addition to color images includes digitally storing a reference image in a database for each multicolor color image to be verified, scanning the printed product uses an imaging sensor, and converts the signal obtained into a digital image file. The digital image file is broken down into regions containing text or graphics and into regions of color images without text or graphics. A statistical descriptive feature of colors occurring and a measure of image sharpness are calculated for each region consisting of a multicolor color image, and are then compared with stored data for the reference image. Deviation rates for the statistical descriptive feature of the colors occurring and for the measure of the image sharpness are calculated and displayed.

### RELATED APPLICATION

This application is the U.S. national phase of PCT/EP2009/002238, filed Mar. 26, 2009, which claims priority to DE 10 2008 016 538.7, filed Mar. 29, 2008.

### FIELD OF THE INVENTION

The invention relates to a method of automatically verifying the visually perceived color impression of multicolor color images in a printed product which includes text in addition to the color images, and further relates to an arrangement for carrying out the method.

### BACKGROUND

The manufacture of printed products with embedded color images such as brochures, catalogs, magazines, art and travel books, posters, etc., is even today a challenging task which makes high demands on an experienced printer. Setting up a new print job and continuously monitoring the visual quality of the printed color images embedded in the text are hardly supported by classical colorimetry which is only applicable to single-color patterns. This applies irrespectively of the printing technology employed, such as, for example, gravure printing, offset printing, or the more recent digital printing processes on the basis of inkjet, xerographic, thermal sublimation, and similar technologies.

At the present time, the printing industry manages with single-color marks that are printed on the right- and left-hand margins in web printing, for example. These single-color surfaces can be measured using conventional colorimeters and photospectrometers. As a rule, this is done by random sampling and offline, based on samples taken manually from a current print job. These colorimetric check measurements determine the differences between the colors of the margin marks of the current job and those of a reference. But the color differences determined, expressed as ΔL[L,a,b] values (ΔL=[L+a²+b²]^{1/2}), for example, merely describe the match of the colors of the margin marks between the current print job and the reference. They say little about the match of the visual color impression of the printed multicolor color images with the color impression of reference color images, which is also dependent on the image sharpness, as set forth in EP 1 642 098, for example.

Because of its basic limitation to monochromaticity, the traditional colorimetry is not able to replace a printer's experienced eye in the assessment of color images. Therefore, a major part of the operating steps in setting up a new print job and during current production today consists in a purely visual comparison of samples, performed by trained printing staff under controlled standard light. This purely visual check is time-consuming and labor-intensive, subjective and highly dependent on the person carrying it out. This unsatisfactory state of the art also accounts for the low productivity of the very expensive printing lines: in many cases, setup and comparison of samples consumes 20 to 30% of the time. Misprints and disputes with the ultimate consumers are frequent and costly due to the purely subjective checks and releases.

For a decorative print, such as, e.g., for floor laminates and patterned furniture fronts, EP 1 642 098 discloses that the visual color impression of a decorative pattern not only depends on a match of the color statistics of the multicolor patterned decorative designs, but that even minor changes in the image sharpness, which are not perceived as such by the eye, create the impression of a color shift in the human visual system. EP 1 642 098 therefore proposes that both the color statistics and the image sharpness of the decorative design being currently printed be continuously measured using color cameras, and that both measurements be displayed to the printer, either separately or in combination to form a common measured value, as a measure of the stability of the visual color impression of the decorative design produced (see also: Massen, R.: “100% automatic monitoring of the consistency of appearance of décor papers in the printing and in the impregnating line”, European Laminates Conference and Workshop, Prague, Czech Republic, 4-6 Apr. 2006, organized by TCM, Austria, www.tcman.at).

In contrast to the very special decorative printing, in multicolor illustrated books, brochures, magazines etc., monochromatic text regions with a large number of different color images, which are printed as pixel matrices, alternate with line graphics, referred to as “graphics” for simplification below. Also, the color images are often additionally partly overprinted with texts. As a result, the teachings of EP 1 642 098 are no longer applicable to these usual printed products:

Color statistics are not a suitable description for monochromatic text regions. When looking at monochromatic texts, the problems involved in perceiving color shifts are not relevant.

When observing monochromatic texts and graphics, the special phenomenon of perception that small changes in the image sharpness cause the impression of a color shift in the human observer does not appear.

The image sharpness of color images overprinted with texts is influenced by the high-contrast transitions from the text characters to the background to a considerably higher degree than by the image sharpness of the structures of the color image itself that are actually of interest.

The integral image sharpness of a color image overprinted with texts therefore does not describe the characteristic of perception of the human visual system underlying EP 1 642 098, namely of perceiving color shifts that do not physically exist, but are caused by small changes in the image sharpness of the color image that are not discernable as such by the observer.

But even in the case of these traditional print jobs of printing multicolor illustrated books, brochures, magazines etc., which are greatly different from decorative printing, it is very important to control the printing process in such a way that the printed color images surrounded by the text and graphical elements will look the same in all of the printed copies of the magazine.

There is therefore a high economic interest in having a method preferably operating in the printing line and an arrangement for carrying out this method, which facilitate the setup of new print jobs and the monitoring of the visual color impression of printed products with color images embedded in texts.

In contrast to classical colorimetry, which is limited to monochromaticity, this method is therefore required to emulate human perception of color images at least in regard to the most important human visual and sensation characteristics that are responsible for a uniform visual quality of printed color images.

### SUMMARY

In one aspect of the invention a method is provided for automatically verifying the visually perceived color impression of multicolor color images in a printed product which includes text and/or line graphics in addition to the color images, the method including the following steps:

a reference image is digitally stored in a database for each multicolor color image to be verified;

the printed product is scanned using an imaging sensor which includes at least n=3 spectral channels, and the signal obtained is converted into a digital image file;

using a method for optical character and pattern recognition and automatic document analysis, the digital image file is broken down into those partial regions containing text and/or line graphics and into such partial regions consisting of multicolor color images without text or line graphics;

at least one statistical descriptive feature of the colors occurring and at least one measure of the image sharpness are calculated for each partial region consisting of a multicolor color image;

the calculated statistical descriptive feature and the measure of the image sharpness are compared with the corresponding statistical descriptive feature and the corresponding measure of the image sharpness of the associated reference image stored in the database; and

a deviation rate for the statistical descriptive feature of the colors occurring and a deviation rate for the measure of the image sharpness are calculated and displayed.

These and other features of the present invention can be best understood from the following specification and drawings, the following of which is a brief description.

### BRIEF DESCRIPTION OF THE DRAWINGS

FIG. 1 shows a page of a magazine with four color images, with text blocks and with graphics;

FIG. 2 shows an arrangement according to the invention for carrying out the method;

FIG. 3 shows the partial regions consisting of multicolor color images without text, following a virtual dissection of the magazine page; and

FIG. 4 schematically shows the comparison of the calculated three-dimensional color histogram with the associated three-dimensional reference color histogram and the comparison of the calculated image sharpness with the corresponding reference image sharpness value of the reference color image stored in a reference database, for a color image of the magazine page.

### DETAILED DESCRIPTION

The concept of the invention will be explained using the continuous check in the printing line of a magazine page as an example, which consists of a plurality of black-and-white text columns and four multicolor color images, one of these color images being additionally partly overprinted with text.

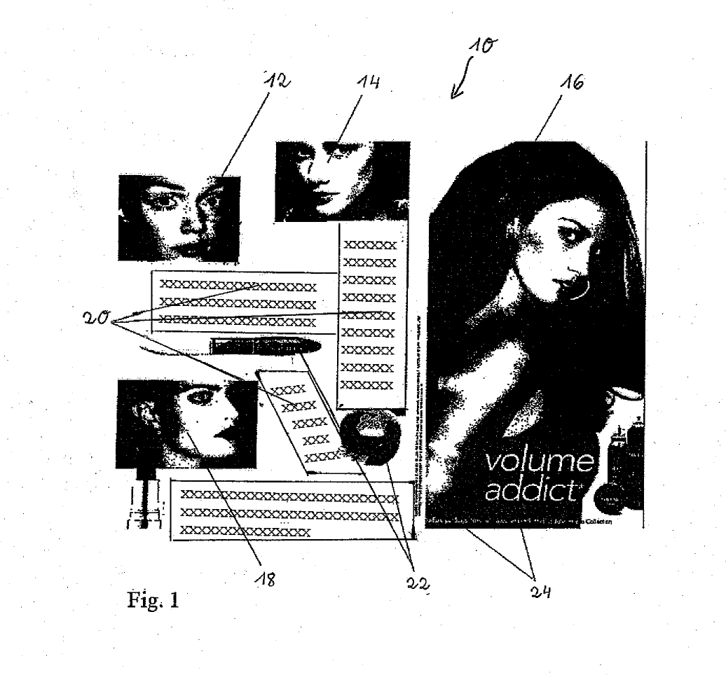

FIG. 1 shows, as a printed product, a page 10 of a magazine with four embedded multicolor color images 12, 14, 16 and 18, which are shown purely in black and white here, with black-and-white text passages 20 and with graphical elements 22. The color image 16 is partly overprinted with text 24.

Magazine pages of this kind are, as a rule, printed in high numbers of units in a printing line. According to the invention, the visual color impression of the multicolor color images 12, 14, 16 and 18 is intended to be verified in running production in that the color statistics of the color images as well as the image sharpnesses of the color images are compared with stored references images and/or color statistics and images sharpnesses calculated from these reference images. The result of this comparison is continuously displayed to the printing staff and provides an information about the visual constancy of the color impression for a human observer and about the physical causes of perceptible deviations, which may reside in deviations in the color statistics and/or in deviations in the image sharpness.

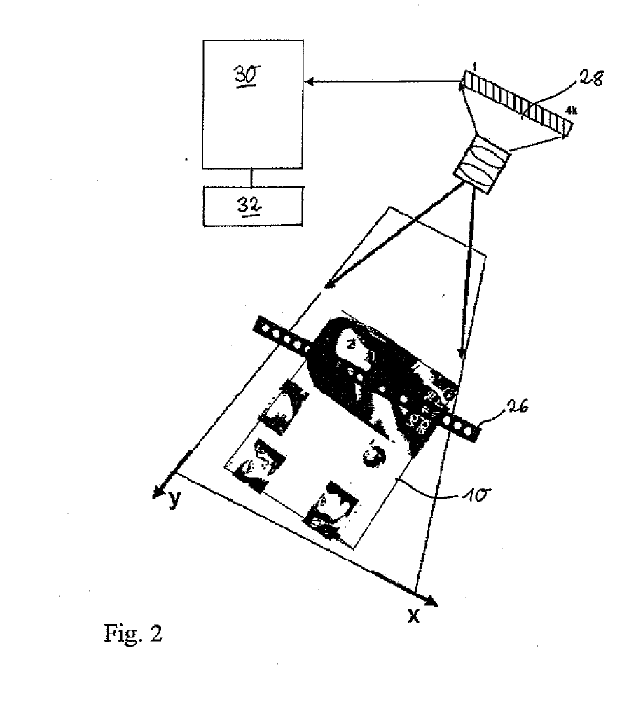

FIG. 2 shows an arrangement according to the invention for automatically verifying the visually perceived color impression of multicolor color images. The magazine page 10 is illuminated in a suitable manner using a line-like white light illumination 26; however, other types of illumination are also possible.

An imaging sensor, which in the embodiment shown is a 3-channel color line camera 28, scans the magazine page 10 in a manner known per se. The limitation to n=3 spectral channels, usually assigned to the colors RED, GREEN and BLUE, should be understood as being an example. The concept of the invention is also applicable to imaging sensors which operate with more than n=3 spectral channels, including those using spectral channels which are outside of human perception. For example, an additional NIR (near infrared) channel is of advantage for scanning the carbon-containing pigments as are used in black text printing and which are particularly well recognizable in this wavelength range. The subsequent character and pattern recognition and document analysis can be facilitated thereby.

It is further known to a person of ordinary skill in the art of image processing that an n-channel color information can also be generated using a black-and-white camera and n spectrally different illuminations in rapid succession, so that such a scanning is also covered by the concept of the invention. Generally, an imaging sensor having n>3 spectral channels is also referred to as a “multispectral camera”.

The scanning process may also be performed in the printing line at high speed. While this is not absolutely necessary, it is useful to carry out the scanning at the end of the printing process, i.e. after the last printing station or printing stage. In multistage print units as are employed when printing an art book including high-quality illustrations, for example, the automatic verification according to the invention may also be performed as early as after a few printing stages, at a time when not all the colors have been printed yet, in order to obtain information about the instability of a particular print unit faster.

The color line camera 28 is connected to an arithmetic unit 30 which, for its part, is connected to a display unit 32. The display unit 32 may be part of the arithmetic unit 30 or a separate part such as, e.g., an LCD display device.

The signals obtained from the color line camera 28 by the scanning process are transferred to the arithmetic unit 30, converted into a digital image file, and stored in this form. Reference images are digitally stored in the arithmetic unit 30 for all multicolor color images to be verified.

The arithmetic unit 30 further comprises programs which, by using an optical character and pattern recognition and an automatic document analysis, can break down each of the image files into those partial regions that include text or graphics, and into such partial regions which consist of multicolor color images without text and/or graphics.

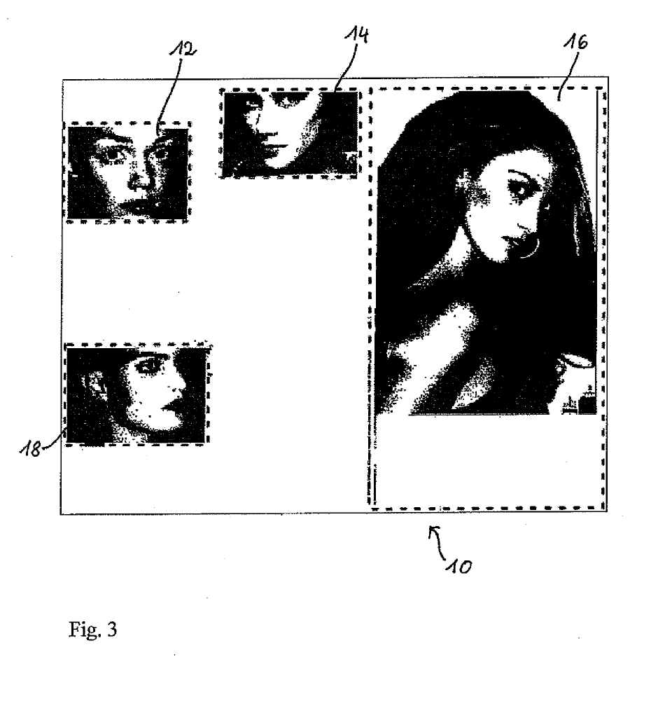

FIG. 3 shows the magazine page 10 after an optical character and pattern recognition and an automatic document analysis. Those partial regions of the magazine page that include text are stopped out and only those text regions that consist of multicolor color images without text are visible. They are automatically found in the digitized image of the magazine page. Such methods of document analysis are employed by the company Océ Document Technologies, Constance (www.captaris-dt.com), for instance, in systems for automatic document capture and management. In addition, in the conference contributions of the 10th Symposium of the Deutsche Arbeitsgemeinschaft für Mustererkennung (DAGM) (German Association for Pattern Recognition) 1988, Zurich, Switzerland, the fundamental principles of automatic document analysis have been published in the following contributions: Achim Luhn, Andreas Dengel: Modellgestiitzte Segmentierung and Hypothesengenerierung für die Analyse von Papierdokumenten, pp. 226-232, and N. Ebi: Objektorientierte Dokumentsegmentierung, pp. 233-239. It may therefore be taken for granted that a person of ordinary skill in the art of image processing is familiar with methods for automatic document analysis including an automatic segmentation of color images.

In the segmented color images, overprinted text passages are recognized and stopped out, where present, using the known methods of character recognition, pattern recognition and automatic analysis of documents. In the color image 16 the region in which the text 24 is situated on the color image is therefore likewise stopped out. In the embodiment described, the graphics 22 in the magazine page are also automatically recognized and stopped out, just like the text.

With the breakdown having been completed, at least one statistical descriptive feature of the colors occurring and at least one measure of the image sharpness are calculated by programs in the arithmetic unit 30 for each of the partial regions which consist of a multicolor color image.

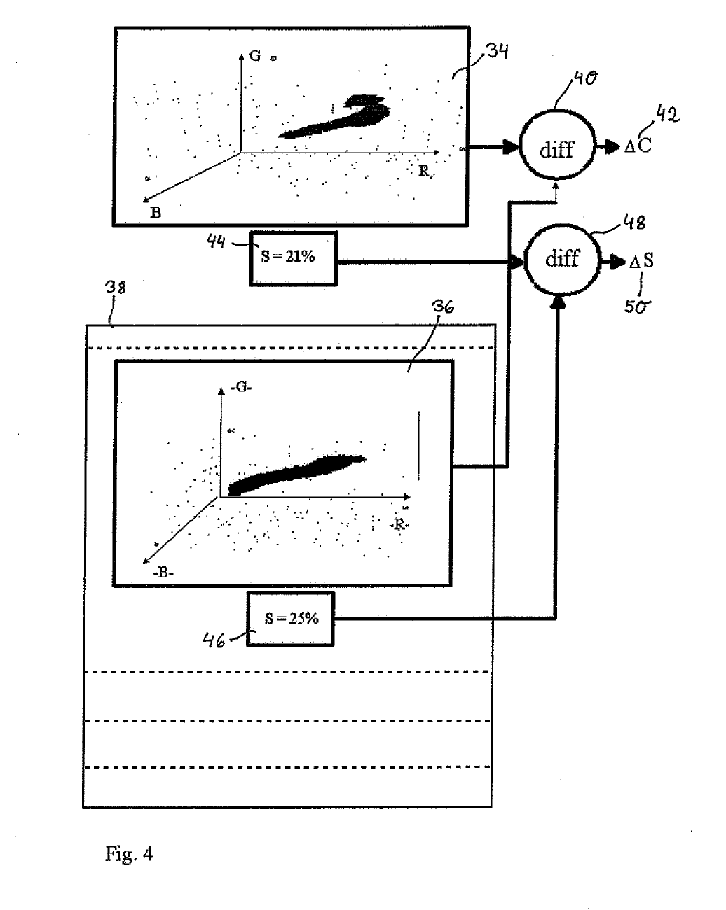

FIG. 4 schematically shows a calculated three-dimensional color histogram 34, for the example of the text-free part of the color image 16, for a statistical description of the colors occurring, as well as the corresponding three-dimensional reference color histogram 36 of the associated reference image stored in a schematically indicated reference database 38. A comparison is made of the two color histograms 34 and 36 with each other in the form of forming a difference 40 resulting in the output of a deviation rate AC 42. The deviation rate AC can be output at the display unit 32.

Furthermore, a measure S of the image sharpness 44 is determined for the text-free part of the color image 16. A measure S of the image sharpness 46 is also calculated for the associated reference image. A comparison is made of the two measures of image sharpness with each other in the form of forming a difference 48 resulting in the output of a deviation rate ΔS 50. The deviation rate ΔS also can be output at the display unit 32. Various embodiments for the display of the deviation rates are conceivable; the deviation rates may be displayed separately, for example, or be combined to form one common deviation rate. Advantageously, the deviation rates are also displayed as trend lines versus the production time and/or the production quantity.

The assignment of a color image to be inspected to the matching reference is performed based on the known positions of the color images on the magazine page, for example. But the assignment may also be effected dynamically in that all entries in the reference database are in each case compared with the values of the current test specimen and the best-matching pairing determines the assignment. Also, rather than displaying each individual deviation rate for each image located on the printed page, it is possible to only display the respectively greatest deviation rate ΔC and the greatest deviation rate ΔS of the page for each printed page.

Since slight differences ΔS in image sharpness are not recognized as such by the human visual system, even by professional printing staff, but are perceived as color shift, it is very important for the printing staff to identify the physical cause of the visible color shift on the basis of the two deviation rates ΔC and ΔS, in order that the appropriate countermeasures can be taken: changes of pigments and color densities for the correction of ΔC, and changes of registration, tensile stress, rheology of the inks, etc., for the correction of ΔS.

The deviation rates are established continuously, so that the printing staff recognizes any instabilities in good time and can take the appropriate countermeasures.

The statistical descriptive features of the color images are not limited to the n-dimensional color histograms that have been mentioned by way of example. Statistical descriptive features of the color images can also be provided by other measures known to a person of ordinary skill in the art of color image processing, such as:

co-occurrence matrices of color images and features calculated therefrom;

features that are descriptive of the geometric distribution of the different colors of a color image;

shape-related features of the shapes, each associated with a color, of the multicolor patterns of a color image;

higher order statistics such as autocorrelation functions; or statistical features calculated from the spatial frequency spectrum or other transformations of the color image.

The method may be applied to all printing technologies and all printable surfaces and materials such as webs, sheets, and surfaces of three-dimensional products such as cans etc.

Although the invention has been described hereinabove with reference to a specific embodiment, it is not limited to this embodiment and no doubt further alternatives will occur to the skilled person that lie within the scope of the invention as claimed.

What is claimed is:

1. A method of automatically verifying a visually perceived color impression of multicolor color images in a printed product which includes text and/or graphics in addition to the multicolor color images, the method comprising the steps of:
(a) digitally storing a reference image in a database for each multicolor color image to be verified;
(b) scanning the printed product using an imaging sensor which includes at least n=3 spectral channels, and converting a signal obtained by scanning into a digital image file;
(c) using a method for optical character and pattern recognition and automatic document analysis to break the digital image file down into partial regions containing text and/or line graphics and into partial regions consisting of multicolor color images without text or line graphics;
(d) calculating at least one statistical descriptive feature of colors occurring and at least one measure of image sharpness for each partial region consisting of a multicolor color image;
(e) comparing the calculated statistical descriptive feature and the measure of the image sharpness with a corresponding statistical descriptive feature and a corresponding measure of the image sharpness of an associated reference image stored in the database; and
(f) calculating and displaying a deviation rate ΔC for the statistical descriptive feature of the colors occurring and a deviation rate ΔS for the measure of the image sharpness.

2. The method according to claim 1, wherein the statistical descriptive feature of the colors occurring is one of the following measures:
n-dimensional color or multispectral histograms;
co-occurrence matrices of the color images and features calculated therefrom;
shape-related features of shapes, each associated with a color, of multicolor patterns of the color images;
higher order statistics such as an autocorrelation function and features calculated therefrom;
features calculated from the spatial frequency spectrum or other transformations of the color image.

3. The method according to claim 1, wherein the measure of the image sharpness is calculated from a number of spectral channels of the color image which is smaller than n.

4. The method according to claim 3, wherein the measure of the image sharpness is calculated in a spatial frequency range that is limited in comparison with a spatial frequency bandwidth of the color image.

5. The method according to claim 1, wherein the measure of the image sharpness is calculated from a transformed color image, a transformation rule being calculated from a linear or nonlinear combination of a number of spectral channels of the color image which is smaller than or equal to n.

6. The method according to claim 5, wherein the measure of the image sharpness is calculated in a spatial frequency range that is limited in comparison with a spatial frequency bandwidth of the transformed color image.

7. The method according to claim 1, wherein the deviation rate for the statistical descriptive feature of the colors occurring and the deviation rate for the measure of the image sharpness are each displayed separately.

8. The method according to claim 1, wherein the deviation rate for the statistical descriptive feature of the colors occurring and the deviation rate for the measure of the image sharpness are displayed as a combined deviation rate.

9. The method according to claim 1, wherein the deviation rate for the statistical descriptive feature of the colors occurring and the deviation rate for the measure of the image sharpness are displayed separately for each color image.

10. The method according to claim 1, wherein for each printed page only the highest deviation rates for the statistical descriptive feature of the colors occurring and for the measure of the image sharpness of all multicolor color images occurring on the printed page are displayed.

11. The method according to claim 1, wherein the deviation rates are displayed as trend lines versus production time and/or production quantity.

12. An arrangement for carrying out a method of automatically verifying a visually perceived color impression of multicolor color images in a printed product which includes text and/or graphics in addition to the color images; comprising:
an imaging sensor which includes at least n=3 spectral channels and is suitable for scanning a printed product which includes color images and text and/or line graphics;
an arithmetic unit to which a signal obtained by the imaging sensor is transferred, the arithmetic unit including programs for
converting the sensor signals into a digital image file;
storing digital reference images in a database;
breaking down each of the image files into those partial regions containing text and/or line graphics and into such partial regions consisting of multicolor color images without text and/or line graphics by an optical character and pattern recognition and an automatic document analysis;
calculating at least one statistical descriptive feature of the colors occurring and at least one measure of the image sharpness for each partial region consisting of a multicolor color image;
comparing the calculated statistical descriptive feature and the measure of the image sharpness with the corresponding statistical descriptive feature and the measure of the image sharpness of the corresponding reference image stored in the database;
calculating a deviation rate ΔC for the statistical descriptive feature of the colors occurring and a deviation rate ΔS for the measure of the image sharpness; and
a display unit connected to the arithmetic unit and suitable for displaying the deviation rate for the statistical descriptive feature of the colors occurring and the deviation rate for the measure of the image sharpness.

13. The arrangement according to claim 12, wherein the imaging sensor is arranged downstream of a last printing station in a production line of the printed product to scan the printed product after the last printing process.

14. The arrangement according to claim 12, wherein the imaging sensor is arranged upstream of a last printing station in a production line of the printed product to scan the printed product before the last printing process.
